(19) United States
(12) Patent Application Publication
(10) Pub. No.: US 2023/0375994 A1
(43) Pub. Date: Nov. 23, 2023

(54) SELECTION OF PRIMARY AND SECONDARY MANAGEMENT CONTROLLERS IN A MULTIPLE MANAGEMENT CONTROLLER SYSTEM

(71) Applicant: Intel Corporation, Santa Clara, CA (US)

(72) Inventors: Francesc GUIM BERNAT, Barcelona (ES); Eoin WALSH, Limerick (IE); Karthik KUMAR, Chandler, AZ (US); Marcos E. CARRANZA, Portland, OR (US)

(21) Appl. No.: 18/228,547

(22) Filed: Jul. 31, 2023

(51) Int. Cl. G05B 19/042

(52) U.S. Cl. CPC G05B 19/042; G05B 2219/2214; G05B 2219/25022

(57) ABSTRACT

Examples described herein relate to a system. In some examples, the system includes an interface and circuitry, coupled to the interface. In some examples, the circuitry, when operational, is to: based on detection of multiple management controllers, select a primary management controller and a secondary management controller from among the multiple management controllers. In some examples, the primary management controller is to perform at least one different operation than that of the secondary management controller, the primary management controller comprises a baseboard management controller (BMC), the secondary management controller comprises a BMC, and the multiple management controllers are positioned in at least one programmable network interface device and a host system.

### BACKGROUND

Data centers include an array of computing platforms with numerous devices that execute software and firmware. Various schemes are available to manage computing platform configurations and monitor computing platform operations. Distributed Management Task Force (DMTF) Redfish® is an example suite of industry standard protocols and application program interfaces (APIs) for out-of-band configuration and management of servers, networks, storage devices, and facilities equipment. In order to make various changes to system configurations, control settings, and/or firmware (e.g., Basic Input Output System (BIOS)), Redfish® protocols access a baseband management controller (BMC).

A computing system can include a central processing unit (CPU) that is to perform compute operations and utilize a BMC on the system to control the system to apply control and policies to the system. Intel® Infrastructure Processing Units (IPUs) provide network connectivity and can execute processes, as an alternative to use of the CPU. IPUs can include BMCs that can supplement the computing system by providing another manner to control and monitor a system, in addition to the BMC utilized by the CPU.

### BRIEF DESCRIPTION OF THE DRAWINGS

FIG. 1 depicts an example system.

FIG. 2 depicts an example process.

FIGS. 3A and 3B depict example network interface devices.

FIG. 4 depicts an example network interface device.

FIG. 5 depicts an example system.

### DETAILED DESCRIPTION

In some cases, multiple BMCs can apply different and, sometimes, conflicting sets of policies, which can lead to inconsistent behavior among different management controllers or live lock or deadlock due to application of conflicting policies. Some examples, described herein provide arbitration circuitry (e.g., circuitry and/or processor-executed software or firmware) to arbitrate among multiple management controllers, such as management controllers on the computing system and the network interface device or other device (e.g., accelerator, graphics processing unit (GPU), memory device, and so forth) so that platform policies can be configured based on priority and a hierarchy can be applied so to reduce a likelihood of inconsistent behavior among different management controllers or live lock or deadlock due to application of conflicting policies. Arbitration circuitry can be validated as trusted to reduce risks of compromising operation of servers by remote control, deployment of malware, implants of ransomware and firmware, and server physical damage (e.g., bricking). Arbitration circuitry can discover various management controllers in a platform and attest management controllers based on proof of identify provided by the management controllers. To reduce a likelihood of conflicting or inconsistent commands from different management controllers, arbitration circuitry can apply an arbitration scheme to select a management controller as a primary management controller and to select a management controller as a secondary management controller where primary and secondary management controllers perform different operations.

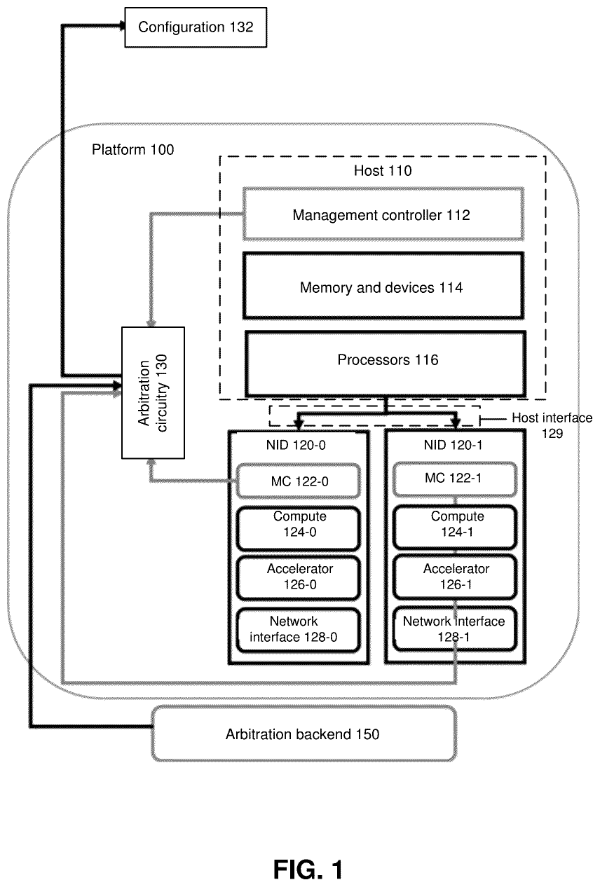

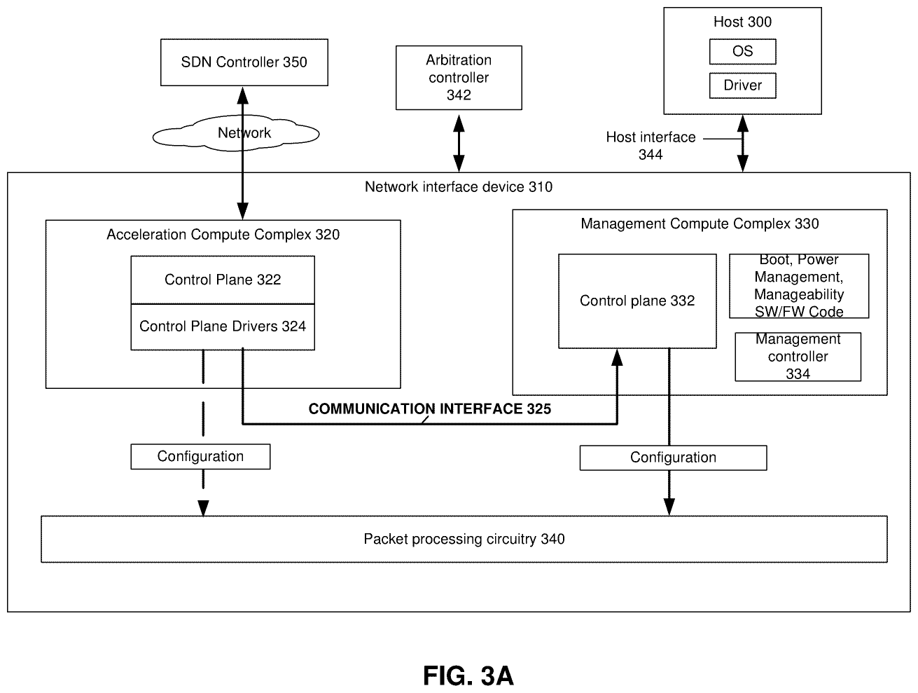

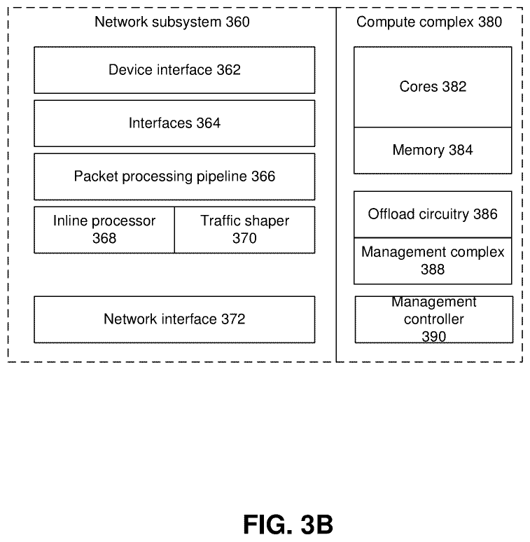

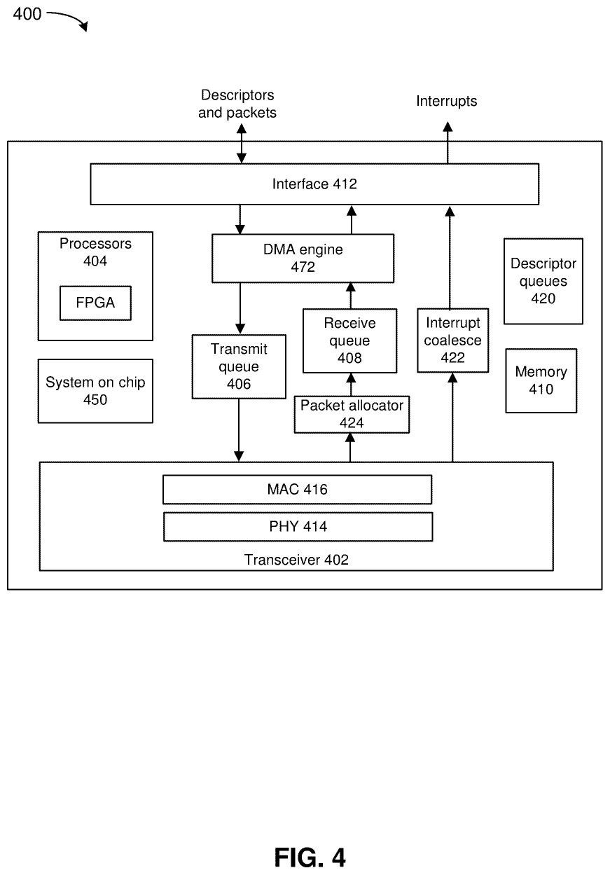

FIG. 1 depicts an example system. Platform 100 can include at least host 110, network interface devices 120-0 to 120-1, and arbitration circuitry 130. Host 110 can include management controller (MC) 112, memory and devices 114, processors 116, as well as other circuitry and software described at least with respect to FIGS. 3A, 3B, 4, and/or 5. Network interface device 120-0 can include management controller (MC) 122-0, compute 124-0 (e.g., CPU, GPU, or other instruction-executing processor), direct memory access (DMA) circuitry (not shown), accelerator 126-0, network interface 128-0, as well as other circuitry and software described at least with respect to FIGS. 3A, 3B, 4, and/or 5. Similarly, network interface device 120-1 can include MC 122-1, compute 124-0 (e.g., CPU, GPU, or other instruction-executing processor), DMA circuitry (not shown), accelerator 126-1, network interface 128-1, as well as other circuitry and software described at least with respect to FIGS. 3A, 3B, 4, and/or 5.

While the examples shown for network interface devices 120-0 and 120-1 are similar, network interface devices 120-0 and 120-1 can include different components and execute different software. Different numbers of network interface devices can be connected to host 110. Host 110 can be communicatively coupled to network interface device 120-0 and/or network interface device 120-1 via host interface 129.

Host interface 129 can communicate in a manner consistent with one or more of: Peripheral Component Interconnect Express (PCIe), Compute Express Link (CXL), Universal Chiplet Interconnect Express (UCIe), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

One or more of management controllers 112, 122-0, and 122-1 can perform management and monitoring capabilities for system administrators to monitor operation at least of host 110 (and devices connected thereto) and network interface devices 120-0 to 120-1 using channels, including channels that can communicate data (e.g., in-band channels) and out-of-band channels. Out-of-band channels can include packet flows or transmission media that communicate metadata and telemetry and may not communicate data. In some examples, one or more of management controllers 112, 122-0, and 122-1 can be communicatively coupled to host 110 can be implemented as one or more of: Board Management Controller (BMC), Intel® Management or Manageability Engine (ME), or other devices.

One or more of management controllers 112, 122-0, and 122-1 can be configured to communicate with arbitration circuitry 130 and arbitration circuitry 130 can send signals to select a primary management controller and secondary management controllers from management controllers 112, 122-0, and 122-1. Arbitration circuitry 130 can configure operations of primary and secondary management controllers and permitted outputs from primary and secondary management controllers, as described herein. Arbitration circuitry 130 can implemented as one or more of: circuitry and/or processor-executed software or firmware. For example, arbitration circuitry 130 can send a signal to management controller 112 of host 110 to indicate management controller 112 of host 110 is a primary or secondary management controller. For example, arbitration circuitry 130 can send a signal to management controller 122-0 of network interface devices 120-0 or send a signal to management controller 122-1 of network interface devices 120-1 to indicate management controller management controller 122-0 or 122-1 is a primary or secondary management controller.

Arbitration circuitry 130 can be connected to host 110 via a circuit board, attached to host 110 via a device interface, or a server in a same data center as that of host 110. Arbitration circuitry 130 can be coupled to management controllers 112, 122-0, and 122-1 using a device interface (e.g., PCIe or CXL) or other interface (e.g., I2C or I3C)).

For example, at boot time of a core of processors 116 (or after boot time), management controllers 112, 122-0, and 122-1 can communicate with arbitration circuitry 130 to access a proof of identify of arbitration circuitry 130 and one or more of management controllers 112, 122-0, and 122-1 can communicate with arbitration backend 150 to attest arbitration circuitry 130. A proof of identity can include a process address space identifier (PASID) or other value. For example, a proof of identity can be based on a hash derived from a public and private key pair (e.g., Rivest-Shamir-Adleman (RSA), Elliptic-curve cryptography (ECC), or others), or blockchain-based identities. Based on attestation of arbitration circuitry 130, management controllers 112, 122-0, and 122-1 can provide associated proof of identifies to arbitration circuitry 130.

Arbitration circuitry 130 can attest management controllers 112, 122-0, and 122-1 with trusted backend 150 based on provided proof of identities from management controllers 112, 122-0, and 122-1. Proof of identities associated with management controllers 112, 122-0, and 122-1 can be based on a PASID or a hash derived from a public and private key pair. In some examples, to attest arbitration circuitry 130 and management controllers 112, 122-0, and 122-1, technologies can be utilized based on Trusted Computing Group (TCG) Device Identifier Composition Engine (DICE) standards (e.g., DICE Attestation Architecture Version 1.00 (2020) and earlier versions, revisions, and variations thereof).

Arbitration circuitry 130 can communicate with backend server 150 to access configuration 132 for platform 100. Based on configuration 132, arbitration circuitry 130 can specify actions a particular management controller is permitted to perform. Based on configuration 132, arbitration circuitry 130 can assign management controllers 112, 122-0, and/or 122-1 a set of associated functionalities and arbitration circuitry 130 can update the associated functionalities out of band or in band with data traffic after initial assignment.

For example, based on configuration 132, arbitration circuitry 130 can select one or more of management controllers 112, 122-0, and/or 122-1 as primary management controller and secondary management controller(s). Based on configuration 132, arbitration circuitry 130 can configure management controllers 112, 122-0, and/or 122-1 to disable or enable certain operations for authorized tenants. An example format of configuration 132 can be as shown in Table 1, however configuration 132 can specify particular operations a particular MC is permitted to perform.

TABLE 1

| Available management controllers | Roles |
|---|---|
| MC 122-0, MC 122-1, MC 112 | MC 112 is Primary |
| MC 122-0, MC 112 | MC 122-0 is Primary |
| MC 122-1, MC 112 | MC 122-1 is Primary |
| MC 122-0, MC 122-1 | MC 122-0 is Primary |

If a particular MC is not identified in configuration 132, arbitration circuitry 130 does not allocate primary or secondary MC roles to such MC not identified in configuration 132 and can issue an alert to an orchestrator or administrator.

In some examples, a primary management controller can perform a set of operations including operations to manage the system and control critical features (e.g., ring 0 type of authentication). Operations to manage the system and control critical features can include one or more of: performing power distribution across the different parts of the system, allocating power management of the host system and the at least one network interface device, configuring frequency or power of operation of cores of host 110 and network interface devices 120-0 and 120-1, memory management of host system 110 and network interface devices 120-0 and 120-1, control of software updates of host system 110 and network interface devices 120-0 and 120-1, or control of firmware updates of host system 110 and network interface devices 120-0 and 120-1.

In some examples, a primary management controller can perform one or more of: retrieval of server identification and asset information (e.g., health state, temperature sensors and fans, power supply output levels, platform power consumption and thresholds), input/output (I/O) infrastructure data (e.g., host network interface controller media access control (MAC) address(es) for devices to be managed (e.g., lights-out management (LOM) devices), hard drive status or fault reporting), network-based discovery of service endpoint, discovery of system topology (e.g., rack, chassis, server, node), reboot or power cycle server with connected devices, change boot order of devices, set power thresholds, alert or event notifications, event log access, access and configure management controller network settings, manage management controller user accounts, or others.

In some examples, after the selection of primary management controller, arbitration circuitry 130 can restrict secondary management controller operations to capturing and monitoring physical state of platform 100 (e.g., power consumption, temperature, and so forth), network and sensors and communicating such information to primary management controller. Primary management controller can transmit such information to a system administrator. For example, primary management controller and/or secondary management controller can perform operations described at least with respect to Redfish® (e.g., Redfish Scalable Platforms Management API Specification version 1.0 (2015) as well as earlier versions, later versions, and variations thereof).

In some examples, primary and secondary management controllers can provide messages and commands to arbitration circuitry 130 and arbitration circuitry 130 can merge the data and provides a status update to the system administrator or arbitration backend 150 for processing. System administrator or arbitration backend 150 can determine an operating status of host 110 such as software versions, firmware versions, power consumption, or temperature. System administrator or arbitration backend 150 can modify software and firmware utilized by host 110 and network interface devices 120-0 and 120-1 based on received status updates.

Arbitration circuitry 130 can act as proxy for management controller outputs (e.g., configuration data and telemetry). Arbitration circuitry 130 can intercept or receive action requests from a particular management controller and check configuration 132 to determine if the action requests are allowed. If the action is allowed, arbitration circuitry 130 can allow the request to go to the corresponding target device within platform 100. If the action is not allowed, arbitration circuitry 130 can reject the request (e.g., not forward the request to the target device), and communicate with back end 150 to raise an error or indicate that an invalid request was issued.

Arbitration backend 150 can host and execute a trusted service that is responsible to provide configuration schemes (e.g., configuration 132) and provide attestation capabilities to attest management controllers and arbitration circuitry 130. Backend 150 can be positioned in either a host system in a data center edge or the cloud.

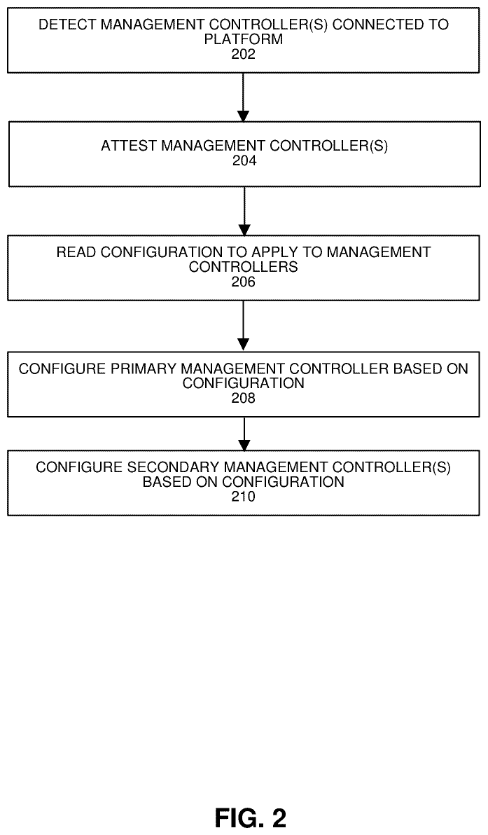

FIG. 2 depicts an example process. The process can be performed by an arbitration circuitry in some examples, a processor core (e.g., a core of processors 116), a management controller, or other circuitry, processor-executed software, or firmware. At 202, detection of management controller(s) connected to a platform can occur. For example, at boot of a management controller, the management controller can indicate a device identifier via a bus or interconnect. At 204, attestation of the detected management controller(s) can occur. Attestation can include verification of the device identifier provided by a management controller. At 206, a configuration to apply to detected management controller(s) can be read. For example, the configuration can indicate particular roles of management controllers in a system, including specifying which management controller in the platform is to be primary management controller and which management controller in the platform is to be a secondary management controller. At 208, based on attestation of multiple management controllers, a primary management controller can be selected from among the detected management controller(s). Selection of primary management controller can be based on the configuration. At 210, second management controller(s) can be selected from among the detected management controller(s) that are not selected as primary management controller. However, if merely a single management controller is detected, the single detected management controller can be selected as the primary management controller and no secondary management controller is selected and if the single management controller is attested, the single management controller can perform configured operations. Thereafter, commands and telemetry output to one or more target devices by primary and secondary management controllers can be in accordance with the configuration. Note that attestation of a management controller and configuration of a management controller as primary or secondary management controller can occur at time intervals, in response to a processor or platform boot, or in response to a request from a system administrator or orchestrator.

FIG. 3A depicts an example system. Host 300 can include processors, memory devices, device interfaces, as well as other circuitry such as described with respect to one or more of FIGS. 3B, 4, and/or 5. Processors of host 300 can execute software such as applications (e.g., microservices, virtual machine (VMs), microVMs, containers, processes, threads, or other virtualized execution environments), operating system (OS), and device drivers. An OS or device driver can configure network interface device or packet processing device 310 to utilize one or more control planes to communicate with software defined networking (SDN) controller 350 via a network to configure operation of the one or more control planes.

Packet processing device 310 can include multiple compute complexes, such as an Acceleration Compute Complex (ACC) 320 and Management Compute Complex (MCC) 330, as well as packet processing circuitry 340 and network interface technologies for communication with other devices via a network. ACC 320 can be implemented as one or more of: a microprocessor, processor, accelerator, field programmable gate array (FPGA), application specific integrated circuit (ASIC) or circuitry described at least with respect to FIGS. 3B, 4, and/or 5. Similarly, MCC 330 can be implemented as one or more of: a microprocessor, processor, accelerator, field programmable gate array (FPGA), application specific integrated circuit (ASIC) or circuitry described at least with respect to FIGS. 3B, 4, and/or 5. In some examples, ACC 320 and MCC 330 can be implemented as separate cores in a CPU, different cores in different CPUs, different processors in a same integrated circuit, different processors in different integrated circuit.

As described herein, management controller 334 can store an encrypted device identifier and provide the device identifier to arbitration circuitry 342 to attest management controller 334. Management controller 334 can receive a configuration from arbitration circuitry 342 of operations to perform, such as where multiple management controllers are operating in a platform. Management controller 334 can perform operations in accordance with the received configuration.

Packet processing device 310 can be implemented as one or more of: a microprocessor, processor, accelerator, field programmable gate array (FPGA), application specific integrated circuit (ASIC) or circuitry described at least with respect to FIGS. 3B, 4, and/or 5. Packet processing pipeline circuitry 340 can process packets as directed or configured by one or more control planes executed by multiple compute complexes. In some examples, ACC 320 and MCC 330 can execute respective control planes 322 and 332.

SDN controller 350 can upgrade or reconfigure software executing on ACC 320 (e.g., control plane 322 and/or control plane 332) through contents of packets received through packet processing device 310. In some examples, ACC 320 can execute control plane operating system (OS) (e.g., Linux) and/or a control plane application 322 (e.g., user space or kernel modules) used by SDN controller 350 to configure operation of packet processing pipeline 340. Control plane application 322 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 350 can communicate with ACC 320 using a remote procedure call (RPC) such as Google remote procedure call (gRPC) or other service and ACC 320 can convert the request to target specific protocol buffer (protobuf) request to MCC 330. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 350 can provide packet processing rules for performance by ACC 320. For example, ACC 320 can program table rules (e.g., header field match and corresponding action) applied by packet processing pipeline circuitry 340 based on change in policy and changes in VMs, containers, microservices, applications, or other processes. ACC 320 can be configured to provide network policy as flow cache rules into a table to configure operation of packet processing pipeline 340. For example, the ACC-executed control plane application 322 can configure rule tables applied by packet processing pipeline circuitry 340 with rules to define a traffic destination based on packet type and content. ACC 320 can program table rules (e.g., match-action) into memory accessible to packet processing pipeline circuitry 340 based on change in policy and changes in VMs.

A flow can be a sequence of packets being transferred between two endpoints, generally representing a single session using a protocol. Accordingly, a flow can be identified, using a match, by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

For example, ACC 320 can execute a virtual switch such as vSwitch or Open vSwitch (OVS), Stratum, or Vector Packet Processing (VPP) that provides communications between virtual machines executed by host 300 or with other devices connected to a network. For example, ACC 320 can configure packet processing pipeline circuitry 340 as to which VM is to receive traffic and what kind of traffic a VM can transmit. For example, packet processing pipeline circuitry 340 can execute a virtual switch such as vSwitch or Open vSwitch that provides communications between virtual machines executed by host 300 and packet processing device 310.

MCC 330 can execute a host management control plane, global resource manager, and perform hardware registers configuration. Control plane 332 executed by MCC 330 can perform provisioning and configuration of packet processing circuitry 340. For example, a VM executing on host 300 can utilize packet processing device 310 to receive or transmit packet traffic. MCC 330 can execute boot, power, management, and manageability software (SW) or firmware (FW) code to boot and initialize the packet processing device 310, manage the device power consumption, provide connectivity to management controller 334 (e.g., Baseboard Management Controller (BMC)), and other operations.

One or both control planes of ACC 320 and MCC 330 can define traffic routing table content and network topology applied by packet processing circuitry 340 to select a path of a packet in a network to a next hop or to a destination network-connected device. For example, a VM executing on host 300 can utilize packet processing device 310 to receive or transmit packet traffic.

ACC 320 can execute control plane drivers to communicate with MCC 330. At least to provide a configuration and provisioning interface between control planes 322 and 332, communication interface 325 can provide control-plane-to-control plane communications. Control plane 332 can perform a gatekeeper operation for configuration of shared resources. For example, via communication interface 325, ACC control plane 322 can communicate with control plane 332 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 325 can be utilized by a negotiation protocol and configuration protocol running between ACC control plane 322 and MCC control plane 332. Communication interface 325 can include a general purpose mailbox for different operations performed by packet processing circuitry 340. Examples of operations of packet processing circuitry 340 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 325 can include one or more mailboxes accessible as registers or memory addresses. For communications from control plane 322 to control plane 332, communications can be written to the one or more mailboxes by control plane drivers 324. For communications from control plane 332 to control plane 322, communications can be written to the one or more mailboxes. Communications written to mailboxes can include descriptors which include message opcode, message error, message parameters, and other information. Communications written to mailboxes can include defined format messages that convey data.

Communication interface 325 can provide communications based on writes or reads to particular memory addresses (e.g., dynamic random access memory (DRAM)), registers, other mailbox that is written-to and read-from to pass commands and data. To provide for secure communications between control planes 322 and 332, registers and memory addresses (and memory address translations) for communications can be available only to be written to or read from by control planes 322 and 332 or cloud service provider (CSP) software executing on ACC 320 and device vendor software, embedded software, or firmware executing on MCC 330. Communication interface 325 can support communications between multiple different compute complexes such as from host 300 to MCC 330, host 300 to ACC 320, MCC 330 to ACC 320, baseboard management controller (BMC) to MCC 330, BMC to ACC 320, or BMC to host 300.

Packet processing circuitry 340 can be implemented using one or more of: application specific integrated circuit (ASIC), field programmable gate array (FPGA), processors executing software, or other circuitry. Control plane 322 and/or 332 can configure packet processing pipeline circuitry 340 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 320 or MCC 330. In some examples, a P4 program can be compiled and provided to MCC 330 to configure packet processing circuitry 340. The following is a JSON configuration file that can be transmitted from ACC 320 to MCC 330 to get capabilities of packet processing circuitry 340 and/or other circuitry in packet processing device 310. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 3B depicts an example network interface device system. Network subsystem 360 can be communicatively coupled to compute complex 380. Device interface 362 can provide an interface to communicate with a host. Various examples of device interface 362 can utilize protocols based on Peripheral Component Interconnect Express (PCIe), Compute Express Link (CXL), or others as well as virtual device interface such as virtual device interfaces.

Interfaces 364 can initiate and terminate at least offloaded remote direct memory access (RDMA) operations, Non-volatile memory express (NVMe) reads or writes operations, and LAN operations. Packet processing pipeline 366 can perform packet processing (e.g., packet header and/or packet payload) based on a configuration and support quality of service (QoS) and telemetry reporting. Inline processor 368 can perform offloaded encryption or decryption of packet communications (e.g., Internet Protocol Security (IPSec) or others). Traffic shaper 370 can schedule transmission of communications. Network interface 372 can provide an interface at least to an Ethernet network by media access control (MAC) and serializer/de-serializer (Serdes) operations.

Cores 382 can be configured to perform infrastructure operations such as storage initiator, Transport Layer Security (TLS) proxy, virtual switch (e.g., vSwitch), or other operations. Memory 384 can store applications and data to be performed or processed. Offload circuitry 386 can perform at least cryptographic and compression operations for host or use by compute complex 380. Offload circuitry 386 can include one or more graphics processing units (GPUs) that can access memory 384. Management complex 388 can perform secure boot, life cycle management and management of network subsystem 360 and/or compute complex 380.

Management controller 390 can operate in a similar manner as that of management controller 334.

FIG. 4 depicts an example network interface device or packet processing device. In some examples, circuitry of network interface device can be utilized as part of a network interface such as for network interface devices described with respect to FIG. 3A or 3B. In some examples, packet processing device 400 can be implemented as a network interface controller, network interface card, a host fabric interface (HFI), or host bus adapter (HBA), and such examples can be interchangeable. Packet processing device 400 can be coupled to one or more servers using a bus, PCIe, CXL, or Double Data Rate (DDR). Packet processing device 400 may be embodied as part of a system-on-a-chip (SoC) that includes one or more processors, or included on a multichip package that also contains one or more processors.

Some examples of packet processing device 400 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 404, transmit queue 406, receive queue 408, memory 410, and bus interface 412, and DMA engine 452. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 414 and media access control (MAC) circuitry 416. PHY circuitry 414 can include encoding and decoding circuitry (not shown) to encode and decode data packets according to applicable physical layer specifications or standards. MAC circuitry 416 can be configured to assemble data to be transmitted into packets, that include destination and source addresses along with network control information and error detection hash values.

Processors 404 can be any a combination of a: processor, core, graphics processing unit (GPU), field programmable gate array (FPGA), application specific integrated circuit (ASIC), or other programmable hardware device that allow programming of network interface 400. For example, a “smart network interface” can provide packet processing capabilities in the network interface using processors 404.

Processors 404 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 404, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 424 can provide distribution of received packets for processing by multiple CPUs or cores using timeslot allocation described herein or RSS. When packet allocator 424 uses RSS, packet allocator 424 can calculate a hash or make another determination based on contents of a received packet to determine which CPU or core is to process a packet.

Interrupt coalesce 422 can perform interrupt moderation whereby network interface interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 provides this coalesced packet to an application.

Direct memory access (DMA) engine 452 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be any type of volatile or non-volatile memory device and can store any queue or instructions used to program network interface 400. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Bus interface 412 can provide an interface with host device (not depicted). For example, bus interface 412 can be compatible with PCI, PCI Express, PCI-x, Serial ATA, and/or USB compatible interface (although other interconnection standards may be used).

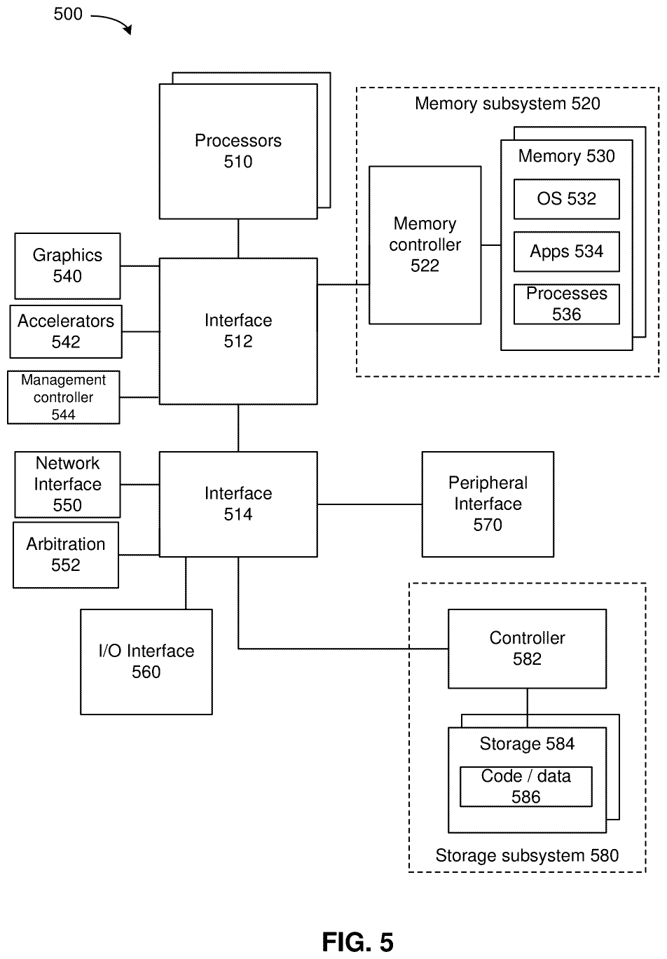

FIG. 5 depicts a system. For example, host 110 can utilize circuitry and/or software of system 500. System 500 includes processor 510, which provides processing, operation management, and execution of instructions for system 500. Processor 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a display that provides an output to a user. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 3A, 3B, or 4.

In some examples, operations of management controller 544 can be configured by arbitration circuitry 552, as described herein. For example, management controller 544 can store an encrypted device identifier and provide the device identifier to an arbitration circuitry (not shown) to attest management controller 544. Management controller 544 can receive a signal from arbitration circuitry 552 indicating that management controller 544 is a primary or secondary management controller. Management controller 544 can receive a configuration from arbitration circuitry 552 of operations to perform and management controller 544 can perform operations in accordance with the received configuration.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) as well as earlier versions, later versions, and variations thereof).

Communications between devices can take place using a network that provides die-to-die communications; chip-to-chip communications; circuit board-to-circuit board communications; and/or package-to-package communications.

In an example, system 500 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: an interface and circuitry, coupled to the interface, the circuitry, when operational, to: based on detection of multiple management controllers, select a primary management controller and a secondary management controller from among the multiple management controllers, wherein: the primary management controller is to perform at least one different operation than that of the secondary management controller, the primary management controller comprises a baseboard management controller (BMC), the secondary management controller comprises a BMC, and the multiple management controllers are positioned in at least one programmable network interface device and a host system.

Example 2 includes one or more examples, wherein the host system comprises a management controller among the multiple management controllers and wherein the circuitry is to provide the host system with a signal that the management controller of the host system is the primary management controller.

Example 3 includes one or more examples, wherein the programmable network interface device comprises a management controller among the multiple management controllers and wherein the circuitry is to provide the programmable network interface device with a signal that the management controller of the programmable network interface device is the primary management controller.

Example 4 includes one or more examples, wherein the primary management controller is to perform at least one different operation than that of the secondary management controller comprises disallow the secondary management controller to output a command that is also output by the primary management controller.

Example 5 includes one or more examples, wherein the primary management controller is to perform at least one different operation than that of the secondary management controller comprises disallow the secondary management controller to output at least one particular command.

Example 6 includes one or more examples, wherein the primary management controller is to perform at least one different operation than that of the secondary management controller comprises allow the primary management controller and the secondary management controller to output particular commands and forward the output particular commands from the primary management controller to a target device but do not forward particular commands from the second management controller to the target device.

Example 7 includes one or more examples, wherein the circuitry is to attest the multiple management controllers and based on attestation of the multiple management controllers, the circuitry is to select the primary management controller and the secondary management controller.

Example 8 includes one or more examples, wherein the primary management controller is to perform one or more of: configure frequency of operation of cores of a host system and at least one network interface device, power management of the host system and the at least one network interface device, memory management of the host system and the at least one network interface device, control of platform updates of the host system and the at least one network interface device, or control of firmware updates of the host system and the at least one network interface device.

Example 9 includes one or more examples, and includes the host system comprising at least one core and a management controller of the multiple management controllers and the at least one programmable network interface device communicatively coupled to the host system via at least one host interface, wherein the at least one programmable network interface device comprises a management controller of the multiple management controllers, a direct memory access (DMA) circuitry, and a network interface.

Example 10 includes one or more examples, wherein the circuitry is positioned in a host system or in a server in a data center.

Example 11 includes one or more examples, and includes a non-transitory computer-readable medium comprising instructions stored thereon, that if executed by one or more processors, cause the one or more processors to: determine if one or multiple management controllers are operating in a platform; based on a determination that one management controller is operating in the platform, permit outputs from the one management controller; and based on a determination that multiple management controllers are operating in the platform, select a primary management controller and a secondary management controller from among the multiple management controllers and permit at least one output from the primary management controller but disallow at least one output from the secondary management controller.

Example 12 includes one or more examples, wherein the permit at least one output from the primary management controller but disallow at least one output from the secondary management controller comprises resolve conflicts among commands from the primary management controller and the secondary management controller.

Example 13 includes one or more examples, wherein the permit at least one output from the primary management controller but disallow at least one output from the secondary management controller comprises disallow the secondary management controller from output of at least one particular command.

Example 14 includes one or more examples, wherein the primary management controller and the secondary management controller are to provide at least one different command.

Example 15 includes one or more examples, and includes instructions stored thereon, that if executed by one or more processors, cause the one or more processors to: attest the multiple management controllers and based on attestation of the multiple management controllers, select the primary management controller and the secondary management controller.

Example 16 includes one or more examples, and includes a method that includes: determining if one or multiple management controllers are operating in a platform; based on a determination that one management controller is operating in the platform, permitting outputs from the one management controller; and based on a determination that multiple management controllers are operating in the platform, selecting a primary management controller and a secondary management controller from among the multiple management controllers and permitting at least one output from the primary management controller but disallow at least one output from the secondary management controller.

Example 17 includes one or more examples, wherein the permitting at least one output from the primary management controller but disallow at least one output from the secondary management controller comprises resolving conflicts among commands from the primary management controller and the secondary management controller.

Example 18 includes one or more examples, wherein the permitting at least one output from the primary management controller but disallow at least one output from the secondary management controller comprises disallowing the secondary management controller from outputting at least one particular command.

Example 19 includes one or more examples, wherein the primary management controller and the secondary management controller are to provide at least one different command.

Example 20 includes one or more examples, and includes attesting the multiple management controllers and based on attestation of the multiple management controllers, selecting the primary management controller and the secondary management controller.

1. An apparatus comprising:
an interface and
circuitry, coupled to the interface, the circuitry, when operational, to:
based on detection of multiple management controllers, select a primary management controller and a secondary management controller from among the multiple management controllers, wherein:
the primary management controller is to perform at least one different operation than that of the secondary management controller,
the primary management controller comprises a baseboard management controller (BMC),
the secondary management controller comprises a BMC, and
the multiple management controllers are positioned in at least one programmable network interface device and a host system.

2. The apparatus of claim 1, wherein the host system comprises a management controller among the multiple management controllers and wherein the circuitry is to provide the host system with a signal that the management controller of the host system is the primary management controller.

3. The apparatus of claim 1, wherein the programmable network interface device comprises a management controller among the multiple management controllers and wherein the circuitry is to provide the programmable network interface device with a signal that the management controller of the programmable network interface device is the primary management controller.

4. The apparatus of claim 1, wherein the primary management controller is to perform at least one different operation than that of the secondary management controller comprises disallow the secondary management controller to output a command that is also output by the primary management controller.

5. The apparatus of claim 1, wherein the primary management controller is to perform at least one different operation than that of the secondary management controller comprises disallow the secondary management controller to output at least one particular command.

6. The apparatus of claim 1, wherein the primary management controller is to perform at least one different operation than that of the secondary management controller comprises allow the primary management controller and the secondary management controller to output particular commands and forward the output particular commands from the primary management controller to a target device but do not forward particular commands from the second management controller to the target device.

7. The apparatus of claim 1, wherein the circuitry is to attest the multiple management controllers and based on attestation of the multiple management controllers, the circuitry is to select the primary management controller and the secondary management controller.

8. The apparatus of claim 1, wherein the primary management controller is to perform one or more of: configure frequency of operation of cores of a host system and at least one network interface device, power management of the host system and the at least one network interface device, memory management of the host system and the at least one network interface device, control of platform updates of the host system and the at least one network interface device, or control of firmware updates of the host system and the at least one network interface device.

9. The apparatus of claim 1, comprising:
the host system comprising at least one core and a management controller of the multiple management controllers and
the at least one programmable network interface device communicatively coupled to the host system via at least one host interface, wherein the at least one programmable network interface device comprises a management controller of the multiple management controllers, a direct memory access (DMA) circuitry, and a network interface.

10. The apparatus of claim 1, wherein the circuitry is positioned in a host system or in a server in a datacenter.

11. A non-transitory computer-readable medium comprising instructions stored thereon, that if executed by one or more processors, cause the one or more processors to:
determine if one or multiple management controllers are operating in a platform;
based on a determination that one management controller is operating in the platform, permit outputs from the one management controller; and
based on a determination that multiple management controllers are operating in the platform, select a primary management controller and a secondary management controller from among the multiple management controllers and permit at least one output from the primary management controller but disallow at least one output from the secondary management controller.

12. The non-transitory computer-readable medium of claim 11, wherein the permit at least one output from the primary management controller but disallow at least one output from the secondary management controller comprises resolve conflicts among commands from the primary management controller and the secondary management controller.

13. The non-transitory computer-readable medium of claim 11, wherein the permit at least one output from the primary management controller but disallow at least one output from the secondary management controller comprises disallow the secondary management controller from output of at least one particular command.

14. The non-transitory computer-readable medium of claim 11, wherein the primary management controller and the secondary management controller are to provide at least one different command.

15. The non-transitory computer-readable medium of claim 11, comprising instructions stored thereon, that if executed by one or more processors, cause the one or more processors to:
attest the multiple management controllers and based on attestation of the multiple management controllers, select the primary management controller and the secondary management controller.

16. A method comprising:
determining if one or multiple management controllers are operating in a platform;
based on a determination that one management controller is operating in the platform, permitting outputs from the one management controller; and
based on a determination that multiple management controllers are operating in the platform, selecting a primary management controller and a secondary management controller from among the multiple management controllers and permitting at least one output from the primary management controller but disallow at least one output from the secondary management controller.

17. The method of claim 16, wherein the permitting at least one output from the primary management controller but disallow at least one output from the secondary management controller comprises resolving conflicts among commands from the primary management controller and the secondary management controller.

18. The method of claim 16, wherein the permitting at least one output from the primary management controller but disallow at least one output from the secondary management controller comprises disallowing the secondary management controller from outputting at least one particular command.

19. The method of claim 16, wherein the primary management controller and the secondary management controller are to provide at least one different command.

20. The method of claim 16, comprising:
attesting the multiple management controllers and based on attestation of the multiple management controllers, selecting the primary management controller and the secondary management controller.
